(19) United States
(12) Patent Application Publication
(10) Pub. No.: US 2023/0259850 A1
(43) Pub. Date: Aug. 17, 2023

(54) AUTOMATICALLY PRESENTING PRODUCTIVITY METRICS

(71) Applicant: About Time Technologies, LLC, Payson, UT (US)

(72) Inventors: Russell I. Hanson, Salem, UT (US); Ryan Remkes, Salem, UT (US); Michael T. Merrill, Salem, UT (US); Kory Tanner, Salem, UT (US)

(21) Appl. No.: 17/670,118

(22) Filed: Feb. 11, 2022

(51) Int. Cl. G06Q 10/06

(52) U.S. Cl. CPC G06Q 10/0633

(57) ABSTRACT

For automatically presenting productivity metrics, a method calculates a current productivity pace for task codes, wherein each productivity pace is measured in output units per input units. The method predicts a needed productivity pace to complete the task codes. The method predicts a productivity delta comprising a difference in input units required to complete each task code and budgeted input units. The method automatically presents presenting productivity metrics with a greatest predicted productivity delta based on organization data, the productivity metrics comprising at least one of the current productivity pace, the needed productivity pace, and the productivity delta.

### FIELD

The subject matter disclosed herein relates to predicting productivity metrics and automatically presenting productivity metrics.

### BACKGROUND

Projects can often go over budget or behind schedule.

### BRIEF SUMMARY

A method for automatically presenting productivity metrics is disclosed. The method calculates a current productivity pace for task codes, wherein each productivity pace is measured in output units per input units. The method predicts a needed productivity pace to complete each task code. The method predicts a productivity delta comprising a difference in input units required to complete each task code and budgeted input units. The method automatically presents presenting productivity metrics with a greatest predicted productivity delta based on organization data, the productivity metrics comprising at least one of the current productivity pace, the needed productivity pace, and the productivity delta. An apparatus and computer program product also perform the functions of the method.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a predictive system;

FIG. 2A is a schematic block diagram illustrating one embodiment of organization data;

FIG. 2B is a schematic block diagram illustrating one embodiment of project data;

FIG. 2C is a schematic block diagram illustrating one embodiment of a task code;

FIG. 2D is a schematic block diagram illustrating one embodiment of tracking data;

FIG. 2E is a schematic block diagram illustrating one alternate embodiment of tracking data;

FIG. 2F is a schematic block diagram illustrating one embodiment of budget data;

FIG. 3A is an illustration showing one embodiment of organization level productivity metrics presented on a mobile device screen;

FIG. 3B is an illustration showing one embodiment of organization level productivity metrics presented in a window;

FIG. 3C is an illustration showing one embodiment of project level productivity metrics presented on a mobile device screen;

FIG. 3D is an illustration showing one embodiment of project level productivity metrics presented in a window;

FIG. 3E is an illustration showing one embodiment of task level productivity metrics presented on a mobile device screen;

FIG. 3F is an illustration showing one embodiment of task level productivity metrics presented in a window;

FIG. 3G is an illustration showing one embodiment of a productivity metric report;

FIG. 3H is an illustration showing one embodiment of productivity metrics presented on a mobile device screen;

FIG. 4 is a schematic block diagram illustrating one embodiment of a computer; and

FIG. 5 is a schematic flow chart diagram illustrating one embodiment of a productivity metric prediction method.

### DETAILED DESCRIPTION

As will be appreciated by one skilled in the art, aspects of the embodiments may be embodied as a system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage medium storing machine readable code, computer readable code, and/or program code, referred hereafter as code. The computer readable storage medium may be tangible, non-transitory, and/or non-transmission. The computer readable storage medium may not embody signals. In a certain embodiment, the storage devices only employ signals for accessing code.

The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

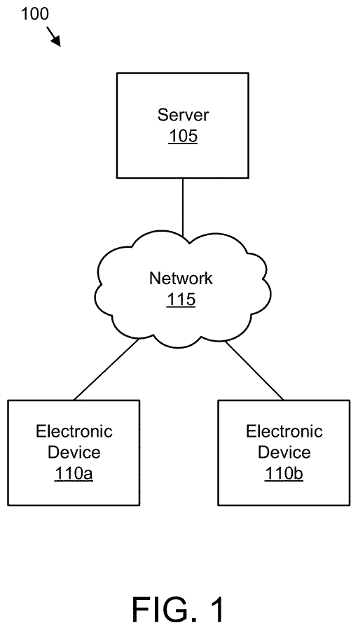

FIG. 1 is a schematic block diagram illustrating one embodiment of a predictive system 100. The system 100 may predict a productivity delta and present productivity metrics. In the depicted embodiment, the system 100 includes a server 105, a network 115, and electronic devices 110. Although one server 105, one network 115, and two electronic devices 110 are shown, any number of servers 105, networks 115, and electronic devices 110 may be employed.

The network 115 may comprise the Internet, a wide area network, a Wi-Fi network, a local area network, a mobile telephone network, or combinations thereof. The server 105 may communicate with the electronic devices 110 via the network 115. In one embodiment, a first electronic device 110a may communicate with a second electronic device 110b via the network 115. An electronic device 110 may be a mobile telephone, a tablet computer, a laptop computer, a computer workstation, and the like.

An electronic device 110 may communicate tracking data to the server 105. The tracking data may be used to track one or more projects within an organization. In addition, the tracking data may be used to generate accounting and/or billing information for the projects. In the past, when a project was completed, it was often discovered that the project was over budget. Unfortunately, when the discovery was made, it was too late to remedy processes to complete the project on time and/or within budget.

The embodiments predict a productivity delta that may comprise a difference in input units required to complete a task code for the project and budgeted inputs for the task code. Productivity metrics are automatically presented for greatest predicted productivity delta, allowing for timely intervention in the project. As a result, the efficiency of the server 105 and the electronic devices 110 in managing the project is improved.

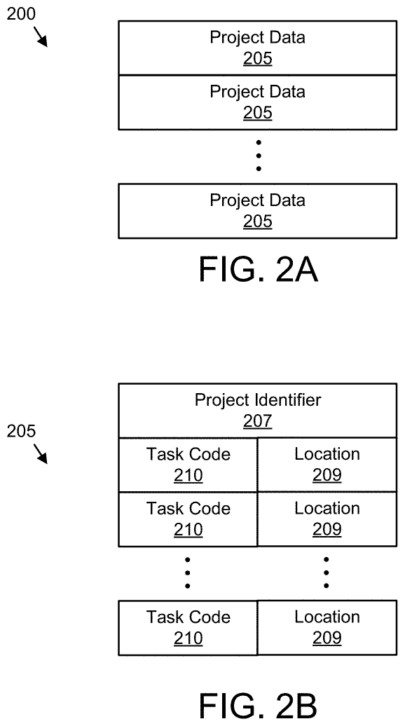

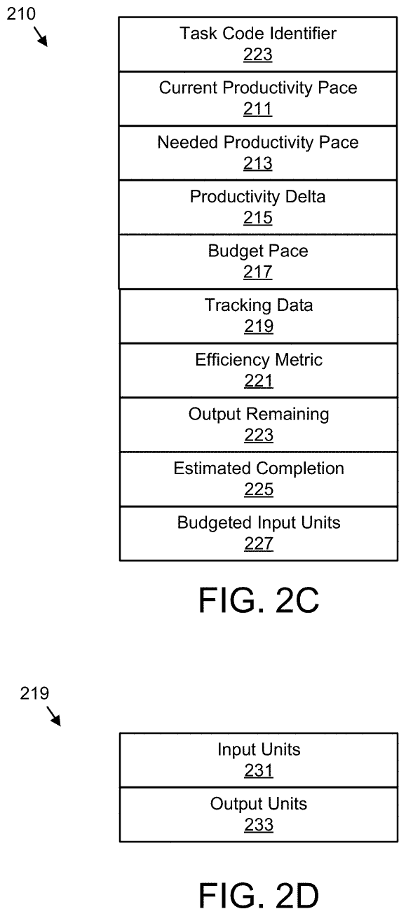

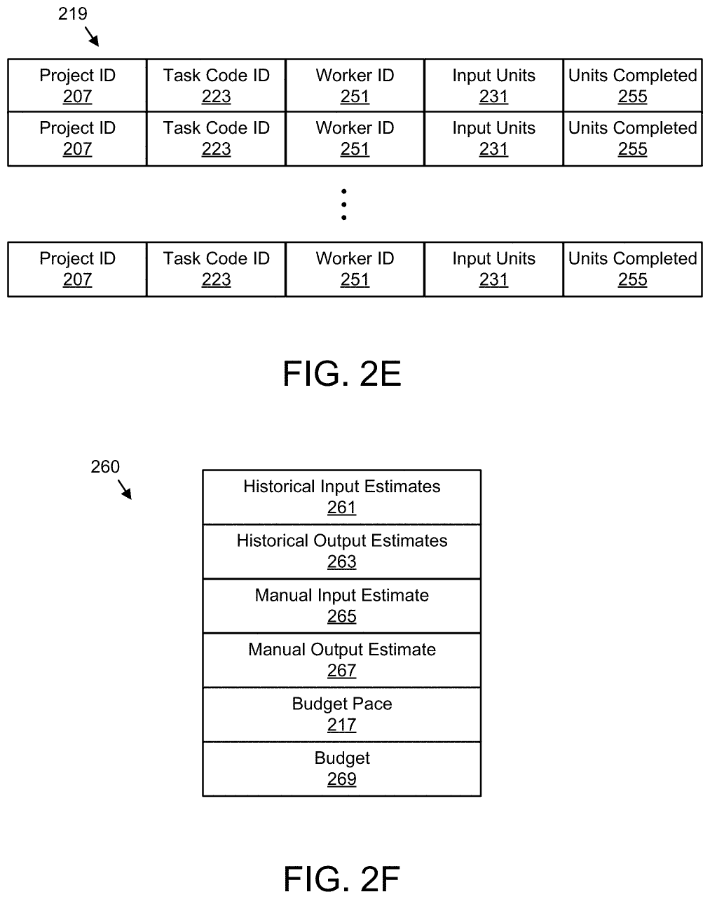

FIG. 2A is a schematic block diagram illustrating one embodiment of organization data 200 for an organization. In the depicted embodiment, the organization data 200 includes project data 205 for a plurality of projects. In one embodiment, the project data 205 is for a location such as a job site. In addition, the project data 205 may be for a plurality of locations. The organization data 200 may be organized as a data structure in a memory.

FIG. 2B is a schematic block diagram illustrating one embodiment of the project data 205. In the depicted embodiment, the project data 205 includes a project identifier 207 and at least one task code 210. The project identifier 207 may uniquely identify a project. Each task code 210 may describe a task required to complete the project associated with the project data 205. In one embodiment, at least one location 209 is associated with each task code 210. In a certain embodiment, a location 209 is associated with a plurality of projects and/or project data 205.

FIG. 2C is a schematic block diagram illustrating one embodiment of a task code 210. The task code 210 may be a cost code. In the depicted embodiment, the task oh 210 includes a task code identifier 223, a current productivity pace 211, a needed productivity pace 213, the productivity delta 215, the budget pace 217, the tracking data 219, an efficiency metric 221, an outputs remaining 223, an estimated completion 225, and budgeted input units 227.

The tracking data 219 may be generated at an electronic device 110 and communicated to the server 105. A worker and/or supervisor may input the tracking data 210. In addition, the tracking data 219 may be automatically generated. The tracking data 219 may be per worker. FIGS. 2D and 2E describe embodiments of the tracking data 219. The output remaining 223 may record uncompleted output units that must be completed before the task code 210 is completed. The estimated completion 225 may record completed output units.

The budgeted input units 227 describe the input units budgeted to complete the task code 210. Budget data is described in more detail in FIG. 2F. The budget pace 217 may describe budgeted input units 227 required to generate the output units required to complete the task code 210. In one embodiment, the budget pace 217 may describe a productivity pace of output units per input units required to complete the task code 210.

The current productivity pace 211 may record a current, live production pace for completing the task code 210. The current productivity pace 211 may be the estimated completion 225 divided by reported input units from the tracking data 219. In one embodiment, the current productivity pace 211 may be continuously updated. In addition, the current productivity pace 211 may be updated in real time. As used herein, a real time update includes scheduling and/or queuing tracking data 219 for the task code 210 for the calculation of the current productivity pace 211 when the tracking data 219 is available at the electronic device 110 and/or server 105. As a result, data update delays are minimized, improving efficiency. The current productivity pace 211 may comprise output units being produced per input unit. In addition, the current productivity pace 211 shows the pace of output units being produced for each task code 210, project, and/or location 209.

The current productivity pace 211 may be expressed in output units per input unit. In one embodiment, the current productivity pace 211 records how many output units have been placed and/or completed and how many input units were required to complete the output units. For example, for a landscaping worker planting trees, if the landscaping worker planted 5 pine trees in 2 hours the current productivity pace 211 is 2.5, 5 output units of trees planted per 2 man-hours of input units.

The needed productivity pace 213 records of pace of completing output units that is needed in relation to the current productivity pace 211 and/or the budget pace 217. In addition, the needed productivity pace 213 may record a pace of completing output units that is needed to stay within budget. The needed productivity pace 213 gives workers a live metric of what needs to happen in order to complete the task code 210 and/or project for the project data 205 within budget.

Continuing the example above, the budget pace 217 may be 10 man-hours to plant 30 trees. As a result, the needed productivity pace 213 is 3 tree output units per man-hour input unit.

The productivity delta 215 may record a difference in input units required to complete the task code (210) and the budget pace (217) for the task code 210. The productivity delta 215 may show workers and staff a real-time, live prediction of how many input units such as man-hours are needed to complete the task code 210 based on the current productivity pace 211 and the needed productivity base 213. In addition, the productivity delta 215 may express an amount of input units over or under the budget pace 217 for the task code 210. In one embodiment, the productivity delta 215 expresses a trend for the project and/or task code 210.

Continuing the example above, the current productivity pace 211 shows the worker doing 2.5 output units of trees planted per 1 man-hours of input units. In addition, the worker has already used up 2 man-hours of input units, leaving only 8 hours left in the budgeted input units 227 (10 budgeted−2 used so far) and an output remaining 223 of 25 trees to plant still (30 trees budgeted−5 complete so far) for a needed productivity pace 213 of 3.125 to finish within budget, calculated as 25 output units to do per 8 man-hour input units to do it in. Thus, the worker's current productivity pace 211 is only 2.5 and the needed productivity pace 213 is 3.125.

The embodiments consider the current productivity pace 211 being produced and measures that against the budget pace 217 and then automatically presents the needed productivity pace 213 and/or needed moving forward in order to finish within budget.

The efficiency metric 221 may record efficiency for a worker, for a project, a task code 210 for a project, a project, and/or an organization. The efficiency metric 221 may be the worker's current productivity pace 211. In addition, the efficiency metric 221 may be a current productivity pace 211 calculated from tracking data 219 from the project data 205 for a plurality of projects. The efficiency metric 221 may be a current productivity pace 211 for a task code 210. In addition, the efficiency metric 221 may be a current productivity pace 211 calculated from tracking data 219 for the task code 210.

FIG. 2D is a schematic block diagram illustrating one embodiment of tracking data 219. In the depicted embodiment, the tracking data 219 includes input units 231 and output units 233.

The input units 231 may be man-hours, equipment hours, material units, energy units, and the like. In one embodiment, the input units 231 are current input units 231 that have been applied to the organization, project and/or location, and/or task code 210. The output units 233 may be tasks, project units, quantifiable units, and the like. The output units 233 may be current output units 233 that is been applied to the organization, project and/or location, and/or task code 210.

FIG. 2E is a schematic block diagram illustrating one alternate embodiment of tracking data 219. The tracking data 219 may track input units 231 and/or output units 233 for a project. The tracking data 219 may be organized as a data structure in a memory. In the depicted embodiment, the tracking data 219 includes a plurality of entries. Each entry may comprise a project identifier 207, the task code identifier 223, a worker identifier 251, input units 231, and units completed 255. In one embodiment, the input units 231 are man-hours. In addition, the units completed 255 may be output units 233, man-hours and/or output units of any type.

FIG. 2F is a schematic block diagram illustrating one embodiment of the budget data 260. The budget data 260 may be used to generate the budget pace 217. The budget pace 217 may record a productivity pace of output units 233 per input units 231 required to complete each task code 210. The budget data 260 may be organized as a data structure in a memory. In the depicted embodiment, the budget data 260 includes historical input estimates 261, historical output estimates 263, a manual input estimate 265, a manual output estimate 267, the budget pace 217, and a budget 269.

The historical input estimates 261 may record a plurality of input units 231 and/or tracking data 219 for a task code 210. The historical output estimates 263 may record a plurality of corresponding output units 233 and/or units completed 255 for the task code 210. The budget pace 217 may be calculated from the historical input estimates 261 and the historical output estimates 263. In one embodiment, the budget pace BP 217 is calculated using Equation 1, where FI is a function of the historical input estimates 261 and FO is a function of the historical output estimates 263. The function may be an average, a median, a mean, and the like.

BP=FO/FI Equation 1

The manual input estimate 265 and the manual output estimate 267 may be input by an administrator and/or user. The manual input estimate 265 and/or the manual output estimate 267 may be specified for the organization, a project, and/or a specific task code 210.

In one embodiment, the budget pace BP 217 is calculated using Equation 2, where am oh is the manual output estimate 267 and MI is the manual input estimate 265. The budgeted input units 227 may be the manual input estimate 265.

BP=MO/MI Equation 2

In one embodiment, the budget 269 is one of the function of the historical output estimates 263 or the manual output estimate 267.

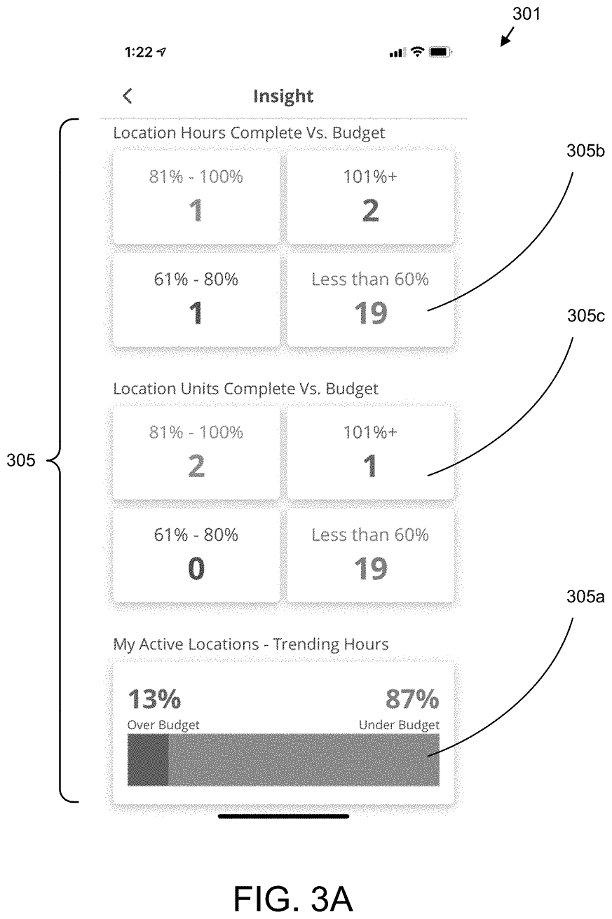

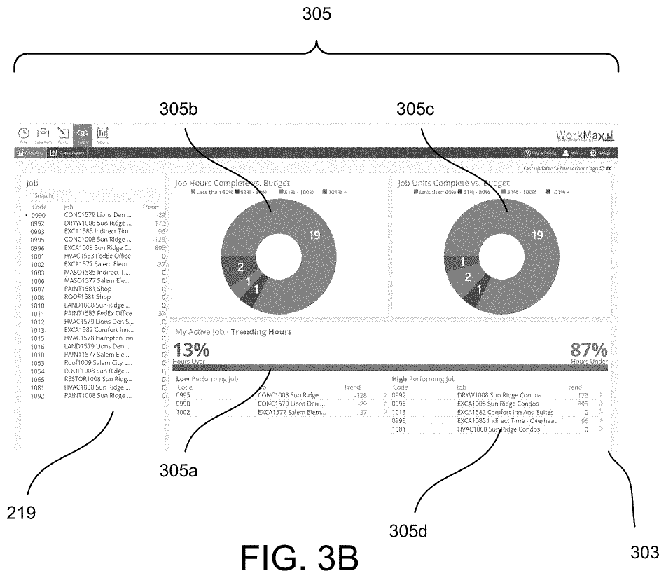

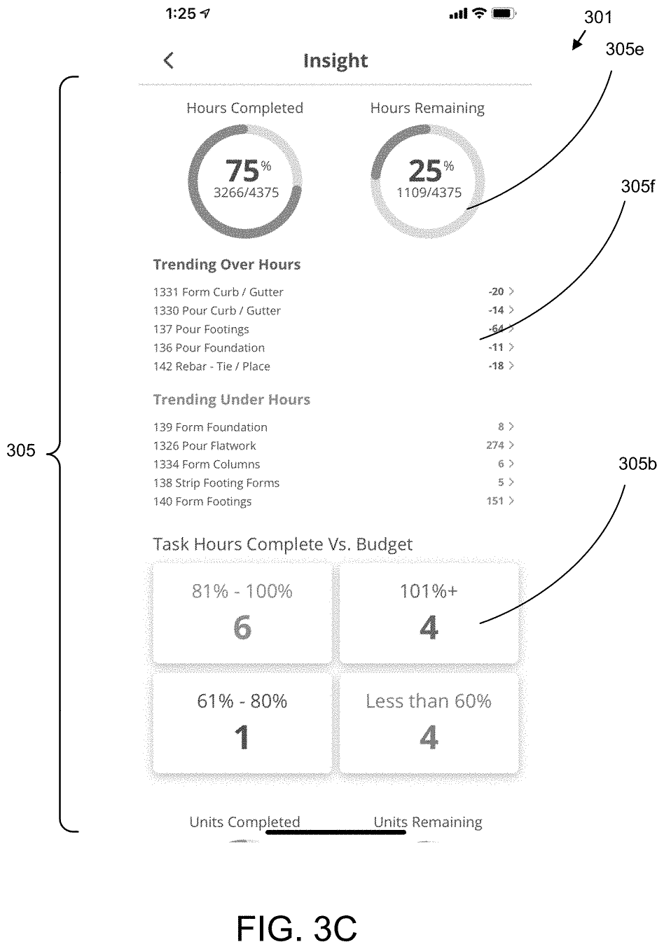

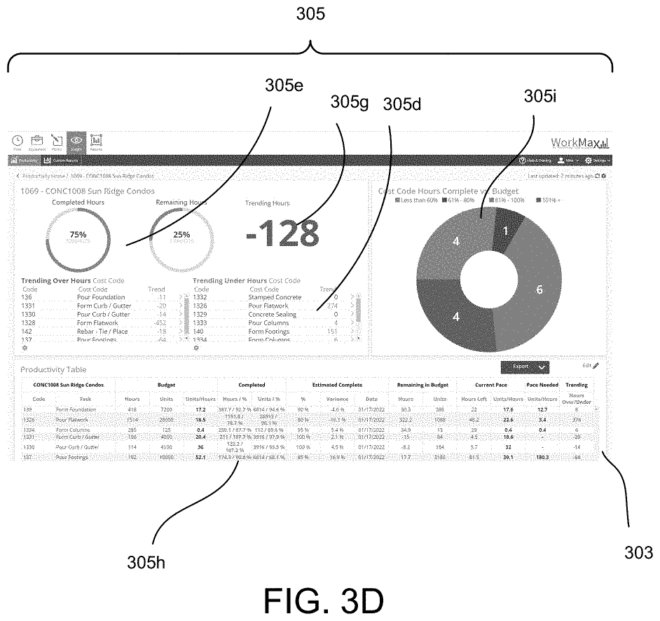

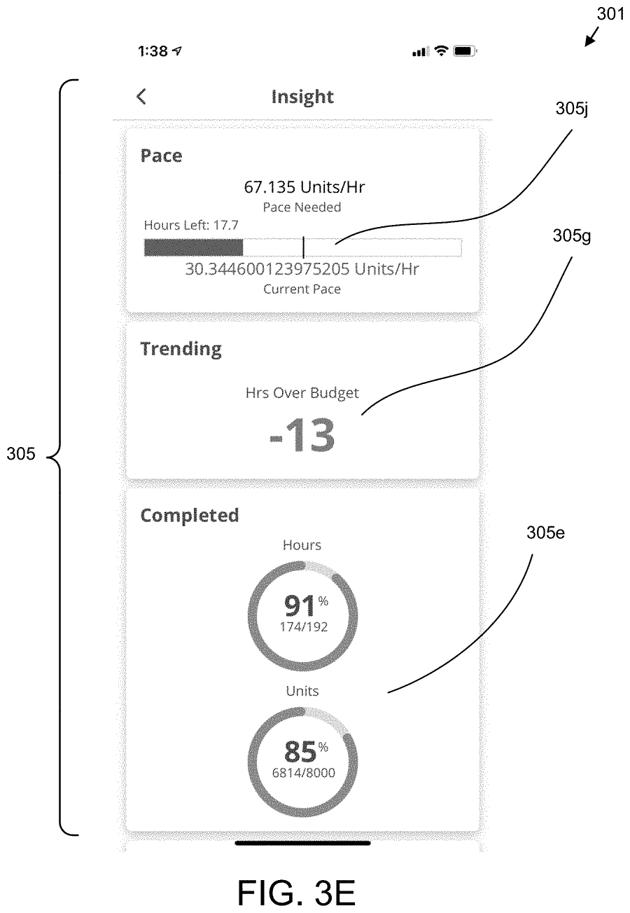

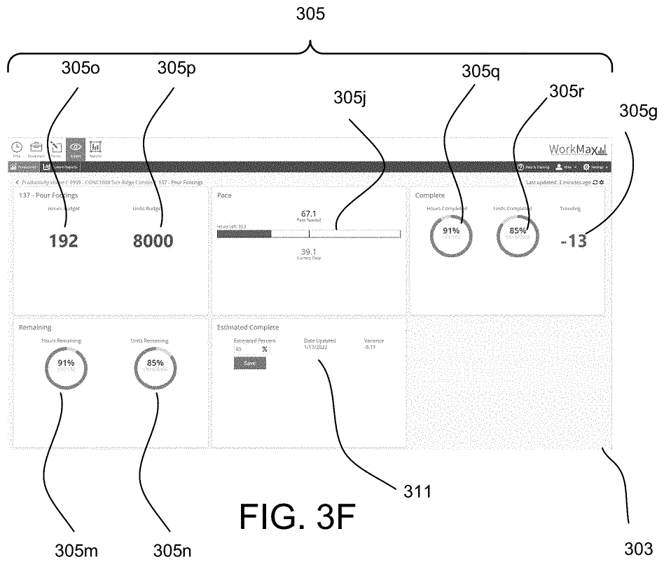

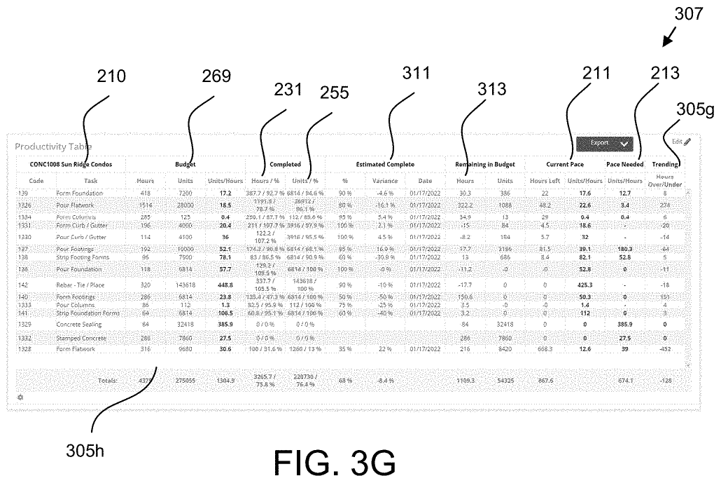

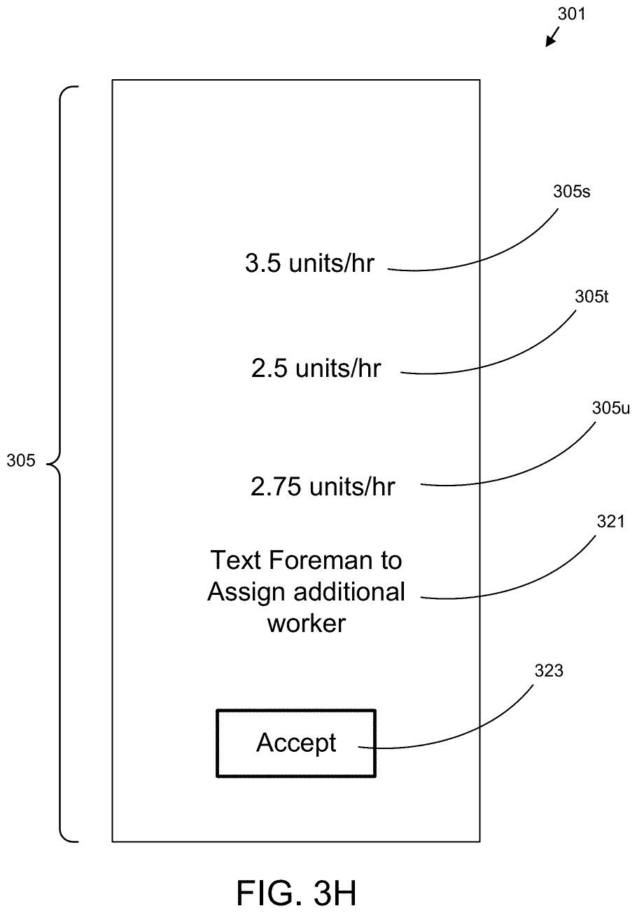

FIG. 3A is an illustration showing one embodiment of organization level productivity metrics 305 presented on a mobile device screen 301. Although for simplicity different productivity metrics 305 are illustrated on either a mobile device screen 301 or in a window, all productivity metrics 305 may be presented on a mobile device screen 301 and/or a window. In the depicted embodiment, the productivity metrics 305 include trending hours bar productivity metrics 305a, a location hours complete versus budget productivity metric 305b, and a location units complete versus budget productivity metric 305c. The trending hours bar productivity matrix 305a shows percentages of locations and/or projects that are over budget and under budget.

The location hours complete versus budget productivity metric 305b shows a number of locations and/or projects that are in various categories of estimated completion 225, hour units completed 255 and/or hour output units 231 in relation to the budget 269. The location units complete versus budget productivity metric 305c shows a number of locations and/or projects that are in various categories of estimated completion 225, units completed 255 and/or output units 231 in relation to the budget 269.

FIG. 3B is an illustration showing one embodiment of organization level productivity metrics 305 presented in a window 303 such as a window 303 of a display. The productivity metrics 305 provide an overall snapshot of productivity for the organization. In the depicted embodiment, the productivity metrics 305 include trending the bar productivity metrics 305a, the location hours complete versus budget productivity metric 305b, and the location units complete versus budget productivity metric 305c. The trending bar productivity matrix 305a shows percentages of locations 209 and/or projects that are over budget 269 and under budget 269. The trending bar productivity matrix 305a may be based on input units 231 such as man-hours.

The location hours complete versus budget productivity metric 305b shows a number of locations and/or projects that are in various categories of estimated completion 225, hour units completed 255, and/or hour output units 231 in relation to the budget 269. The location units complete versus budget productivity metric 305c shows a number of locations 209 and/or projects that are in various categories of estimated completion 225, units completed 255, and/or output units 231 in relation to the budget 269.

In the depicted embodiment, tracking data 219 is also presented. In one embodiment, trending data productivity metrics 305d are also presented.

FIG. 3C is an illustration showing one embodiment of project level productivity metrics 305 presented on a mobile device screen 301. The productivity metrics 305 provide readily understandable and actionable productivity information for a project and/or location 209. The productivity metrics 305 include a units completed versus units remaining productivity metric 305e, a trending units over/under productivity metric 305f, and the location hours complete versus budget productivity metric 305b.

In the depicted embodiment, the units completed versus units remaining productivity metric 305e is a graph showing input units 231 completed versus remaining budgeted input inputs 227. The input units 231 may be man-hours. In addition, the units completed versus units remaining productivity metric 305e may be based on the output remaining 223 and the estimated completion 225 along with one of the budget pace 217 and the current productivity pace 211.

The trending units over/under productivity metric 305f may present task codes 210 that are trending over budget 269 and/or under budget 269. The budget pace 217 may be used to calculate the trending units over/under productivity metrics 305f.

FIG. 3D is an illustration showing one embodiment of project level productivity metrics 305 presented in a window 303. The productivity metrics 305 include the units completed versus units remaining productivity metric 305e for task codes 210, trending data productivity metrics 305d for the project and/or location 209, task code hours complete versus budget productivity metric 305i, a trending units productivity metric 305g, and tabular productivity metrics 305h.

The task code hours complete versus budget productivity metric 305i shows a number of task codes 210 that are in various categories of hour units completed 255 and/or hour output units 231 in relation to the budget 269. The trending units productivity metric 305g shows a trend of input units 231 such as man-hours that are over or under budget 269. The tabular productivity matrix 305h displays detailed information as will be described in FIG. 3G.

FIG. 3E is an illustration showing one embodiment of task level productivity metrics 305 presented on a mobile device screen 301. In the depicted embodiment, the productivity metrics 305 include a pace productivity metric 305j, the trending units productivity metric 305g, and the units completed versus units remaining productivity metric 305e.

In one embodiment, the pace productivity metric 305j presents the current productivity pace 211 and the needed productivity pace 213. In the depicted embodiment, the current productivity pace 211 and the needed productivity pace 213 are presented in a bar graph. Alternatively, the current productivity pace 211 and the needed productivity pace 213 may be presented as historical line graphs, bar graphs, and the like.

FIG. 3F is an illustration showing one embodiment of task level productivity metrics 305 presented in a window 303. In the depicted embodiment, the productivity matrix 305 include an hours budget productivity metric 305o, a units budget productivity metric 305p, the pace productivity metric 305j, an hours completed productivity metric 305q, a units completed productivity metric 305r, the trending units productivity metric 305g, an hours remaining productivity metric 305m, a units remaining productivity metric 305n, and an estimated complete input 311.

The hours budget productivity metric 305o shows the hours input units budget 269 for a task code 210. The units budget productivity metric 305p shows the output units budget 269 for the task code 210. The hours completed productivity metric 305q shows the hours input units 231 completed for the task code 210. The units completed productivity metric 305r shows the units input units 231 completed for the task code 210. The hours remaining productivity metric 305m shows the hours input units 231 remaining for the task code 210. The units remaining productivity metric 305n shows the unit input units 231 remaining for the task code 210. The estimated complete input 309 receives an estimate of the task code 210 that has been completed. The estimated complete input 311 may update the units completed 255.

FIG. 3G is an illustration showing one embodiment of a productivity metric report 307. The productivity metric report 307 may be displayed and/or printed. In the depicted embodiment, the report 307 includes the tabular productivity metrics 305h. The tabular productivity metrics 305h show task codes 210 and corresponding budgets 269 expressed in hours, units, and/or units per hour. In addition, the tabular productivity metrics 305h show corresponding input units 231, units completed 255, the estimated complete input 311, remaining budget hours 313, and remaining budget units 315. The remaining budget hours 313 may be the hours budget 269 minus the input units 231. The remaining budget units 315 may be the units budget 269 minus the estimated completion 225.

In one embodiment, the tabular productivity metrics 305h include the current productivity pace 211 and the needed productivity pace 213., The tabular productivity metrics 305h may include the trending units productivity metric 305g.

FIG. 3H is an illustration showing one embodiment of productivity metrics 305 presented on a mobile device screen 301. In the depicted embodiment, the productivity metrics 305 include a needed pace productivity metric 305s a current pace productivity metric 305t, the pace productivity metric 305u. In one embodiment, an intervention suggestion 321 and intervention accept button 323 are shown.

The current pace productivity metric 305t may show a current productivity pace 211 for a project, a location 209, and/or a task code 210. The needed pace productivity metric 305s may show a needed productivity pace 213 for the project, location 209, and/or the task code 210. In one embodiment, the pace productivity metric 305u shows the efficiency metric 221.

The intervention suggestion 321 suggests an intervention to achieve the needed productivity pace 213. In the depicted embodiment, the intervention suggestion 321 is to text a foreman to assign an additional worker. The intervention suggestion 321 may be to text, email, and/or call staff included foremen, supervisors, staffing agencies, and/or workers. The intervention accept button 323 initiates the intervention suggestion 321. In one embodiment, activating the intervention accept button 323 drafts and/or sends an email or text, initiates a call, or the like.

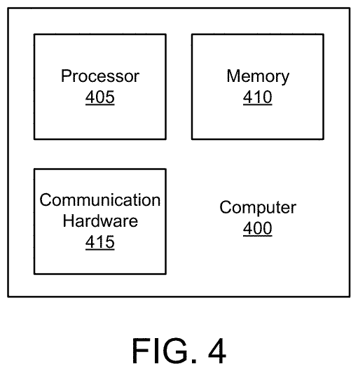

FIG. 4 is a schematic block diagram illustrating one embodiment of a computer 400. The computer 400 may be embodied in the server 105 and/or the electronic devices 110. In the depicted embodiment, the computer 400 includes a processor 405, a memory 410, and communication hardware 415. The memory 410 may store code and data. The processor 405 may execute the code and process the data. The communication hardware 415 may communicate with other devices such as the network 115.

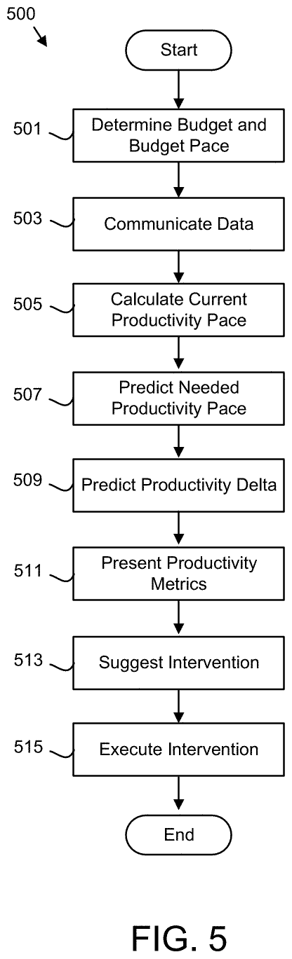

FIG. 5 is a schematic flow chart diagram illustrating one embodiment of a productivity metric prediction method 500. The productivity metric prediction method 500 may automatically present productivity metrics 305. The method 500 may be performed by the computer 400 and/or the processor 405.

The method 500 starts, and in one embodiment, the processor 405 determines 501 the budget 269. In addition, the processor 405 may determine 501 the budget pace 217. In one embodiment, the budget 269 and/or budget pace 217 is determined 501 from the budget data 260.

The processor 405 may communicate 503 organization data 200 from the server 105 to the electronic devices 110. In addition, the processor 405 may communicate 503 the organization data 200 from the electronic devices 110 to the server 105. The organization data 200 may be communicated 503 in real time.

The processor 405 may calculate 505 the current productivity pace 211 for a task code 210. In one embodiment, the current productivity pace 211 is calculated 505 for a plurality of task codes 210 of an organization, a project, and/or location 209. The current productivity pace 211 may be calculated from tracking data 219 received from at least one electronic device 110. Each productivity pace PP 211/213 is measured in output units OU 233 per input units IU 231. One embodiment, the current productivity pace PP 211 is calculated using Equation 3.

PP=OU/IU Equation 3

The processor 405 may predict 307 the needed productivity pace 213 for the task code 210 or plurality of task codes 210. The needed productivity pace 213 may predict the output units 233 that must be completed per input unit 231 to complete the task code 210 within budget 269. The needed productivity pace 213 may be a linear function of the output remaining 223 and/or the estimated completion 225. Alternatively, the needed productivity pace 213 may be a curve fitting estimate of tracking data 219.

In one embodiment, the processor 405 predicts 509 the productivity delta 215 for the task code 210 or plurality of task codes 210. The productivity delta PD 215 may be a difference in input units IU 231 required to complete the task code 210 and/or plurality of task codes 210 and an input unit budget IUB 269 as shown in equation 4.

PD=IU−IUB Equation 4

In one embodiment, the productivity delta PD 215 is calculated as shown in Equation 5, where CPP is the current productivity pace 211 and NPP is the needed productivity pace 213.

PD=CPP−NPP Equation 5

Processor 405 may further automatically present 511 the productivity metrics 305. In one embodiment, productivity metrics 305 are presented for the task codes 210, locations 209, and/or project data 205 with the greatest predicted productivity delta 215. In addition, the productivity metrics 305 may be presented 511 a lowest efficiency metric 221. The productivity metrics 305 may be based on the organization data 200. The productivity metrics 305 may be presented as shown in FIGS. 3A-H.

The productivity metrics 305 may be presented for at least one of the task code 210, project data 205 comprising a plurality of task codes (210), a location 209 comprising a plurality of task codes 210, and an organization. The productivity metrics 305 may presented on at least one electronic device 110. In addition, the productivity metrics 305 may be concurrently presented on a plurality of electronic devices 110.

By automatically presenting 511 the productivity metrics 305, organization management can immediately take action to remedy to meet budget and/or meet schedule. As a result, the efficiency of the system 100 is improved.

In one embodiment, the processor 405 suggests 513 the intervention suggestion 321. The intervention suggestions 321 may be to add input units 231 as illustrated in FIG. 3H. In addition, the processor 405 may execute 515 the intervention suggestion 321 in response to activation of the intervention accept button 323. For example, the processor 405 may draft and send a text message requesting the addition of the input units 231.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
calculating, by use of a processor, a current productivity pace (211) for task codes (210), wherein each productivity pace is measured in output units (233) per input units (231);
predicting a needed productivity pace (213) to complete each task code (210);
predicting a productivity delta (215) comprising a difference in input units (231) required to complete each task code (210) and budgeted input units (227B); and
automatically presenting productivity metrics (305) with a greatest predicted productivity delta (215) based on organization data (200), the productivity metrics (305) comprising at least one of the current productivity pace (211), the needed productivity pace (213), and the productivity delta (215).

2. The method of claim 1, wherein the productivity metrics (305) are presented for at least one of the task code (210), project data (205) comprising a plurality of task codes (210) and organization data (200).

3. The method of claim 1, wherein the productivity metrics (305) are presented on at least one electronic device (110).

4. The method of claim 1, wherein the current productivity pace (211) is calculated from tracking data (219) received from at least one electronic device (110).

5. The method of claim 1, wherein the productivity metrics (305) further comprise an efficiency metric (221) and tracking data (219) is per worker.

6. The method of claim 1, wherein the budget pace (217) is calculated from a same task code (210) from historical project data (205).

7. The method of claim 1, wherein input units (231) are man-hours.

8. An apparatus comprising:
a processor executing code stored in a memory to perform:
calculating a current productivity pace (211) for task codes (210), wherein each productivity pace is measured in output units (233) per input units (231);
predicting a needed productivity pace (213) to complete each task code (210);
predicting a productivity delta (215) comprising a difference in input units (231) required to complete each task code (210) and budgeted input units (227B); and
automatically presenting productivity metrics (305) with a greatest predicted productivity delta (215) based on organization data (200), the productivity metrics (305) comprising at least one of the current productivity pace (211), the needed productivity pace (213), and the productivity delta (215).

9. The apparatus of claim 8, wherein the productivity metrics (305) are presented for at least one of the task code (210), project data (205) comprising a plurality of task codes (210) and organization data (200).

10. The apparatus of claim 8, wherein the productivity metrics (305) are presented on at least one electronic device (110).

11. The apparatus of claim 8, wherein the current productivity pace (211) is calculated from tracking data (219) received from at least one electronic device (110).

12. The apparatus of claim 8, wherein the productivity metrics (305) further comprise an efficiency metric (221) and tracking data (219) is per worker.

13. The apparatus of claim 8, wherein the budget pace (217) is calculated from a OZ same task code (210) from historical project data (205).

14. The apparatus of claim 8, wherein input units (231) are man-hours.

15. A computer program product comprising a non-transitory computer readable storage medium storing code executable by a processor to perform:
calculating a current productivity pace (211) for task codes (210), wherein each productivity pace is measured in output units (233) per input units (231);
predicting a needed productivity pace (213) to complete each task code (210);
predicting a productivity delta (215) comprising a difference in input units (231) required to complete each task code (210) and budgeted input units (227B); and
automatically presenting productivity metrics (305) with a greatest predicted productivity delta (215) based on organization data (200), the productivity metrics (305) comprising at least one of the current productivity pace (211), the needed productivity pace (213), and the productivity delta (215).

16. The computer program product of claim 15, wherein the productivity metrics (305) are presented for at least one of the task code (210), project data (205) comprising a plurality of task codes (210) and organization data (200).

17. The computer program product of claim 15, wherein the productivity metrics (305) are presented on at least one electronic device (110).

18. The computer program product of claim 15, wherein the current productivity pace (211) is calculated from tracking data (219) received from at least one electronic device (110).

19. The computer program product of claim 15, wherein the productivity metrics (305) further comprise an efficiency metric (221) and tracking data (219) is per worker.

20. The computer program product of claim 15, wherein the budget pace (217) is calculated from a same task code (210) from historical project data (205).
